(19) United States
(12) Patent Application Publication
(10) Pub. No.: US 2023/0095093 A1
(43) Pub. Date: Mar. 30, 2023

(54) TRAINING METHOD AND APPARATUS FOR A TARGET DETECTION MODEL, TARGET DETECTION METHOD AND APPARATUS, AND STORAGE MEDIUM

(71) Applicant: BEIJING BAIDU NETCOM SCIENCE TECHNOLOGY CO., LTD., Beijing (CN)

(72) Inventors: Xiaoqing YE, Beijing (CN); Hao SUN, Beijing (CN)

(73) Assignee: BEIJING BAIDU NETCOM SCIENCE TECHNOLOGY CO., LTD., Beijing (CN)

(21) Appl. No.: 17/807,369

(22) Filed: Jun. 16, 2022

(30) Foreign Application Priority Data
Sep. 29, 2021 (CN) 202111153982.4

(51) Int. Cl. G06V 10/776; G06V 20/64; G06V 10/774; G06V 10/22; G06V 10/764; G06V 10/74

(52) U.S. Cl. CPC G06V 10/776; G06V 20/64; G06V 10/774; G06V 10/22; G06V 10/764; G06V 10/761; G06V 2201/07

(57) ABSTRACT

Provided are a training method and apparatus for a target detection model, a target detection method and apparatus, a device, and a media, which relates to the field of artificial intelligence and, in particular, to computer vision and deep learning technologies, which may be applied to 3D visual scenes. A specific implementation includes acquiring a sample image marked with a difficult region; inputting the sample image into a first target detection model and calculating a first loss corresponding to the difficult region; and increasing the first loss and training the first target detection model according to the increased first loss. In this manner, the accuracy of target detection can be improved and the cost of target detection can be reduced.

### CROSS-REFERENCE TO RELATED APPLICATION(S)

This application claims the priority to Chinese Patent Application No. CN202111153982.4 and filed on Sep. 29, 2021, the disclosure of which is incorporated herein by reference in its entirety.

### TECHNICAL FIELD

The present disclosure relates to the field of artificial intelligence, in particular, to computer vision and deep learning technologies, which may be applied to 3D visual scenes, and in particular, to a training method and apparatus for a target detection model, a target detection method and apparatus, a device, and a media.

### BACKGROUND

Computer vision technology is precisely a function for giving a computer the visual recognition and localization of human beings. Through complex image calculations, the computer can identify and locate a target object.

3D target detection is mainly used for detecting 3D objects, where the 3D objects are generally represented by parameters such as spatial coordinates (x, y, z), dimensions (a length, a width, and a height), and an orientation angle.

### SUMMARY

The present disclosure provides a training method and apparatus for a target detection model, a target detection method and apparatus, a device, and a storage medium.

According to an aspect of the present disclosure, a training method for a target detection model is provided. The method includes steps described below.

A sample image marked with a difficult region is acquired.

The sample image is inputted into a first target detection model and a first loss corresponding to the difficult region is calculated.

The first loss is increased and the first target detection model is trained according to the increased first loss.

According to one aspect of the present disclosure, a target detection method is further provided. The method includes steps described below.

An image is inputted into a target detection model, and a 3D target space and a target category of the 3D target space are identified in the image.

The target detection model is trained and obtained according to the training method for a target detection model according to any embodiment of the present disclosure.

According to an aspect of the present disclosure, a training apparatus for a target detection model is provided. The apparatus includes at least one processor and a memory communicatively connected to the at least one processor.

The memory stores instructions executable by the at least one processor, and the instructions are executed by the at least one processor to cause the at least one processor to perform steps in a sample image acquisition module, a space loss calculation module, and a space loss adjustment module.

The sample image acquisition module is configured to acquire a sample image marked with a difficult region.

The space loss calculation module is configured to input the sample image into a first target detection model and calculate a first loss corresponding to the difficult region.

The space loss adjustment module is configured to increase the first loss and train the first target detection model according to the increased first loss.

According to an aspect of the present disclosure, a target detection apparatus is further provided. The apparatus includes at least one processor and a memory communicatively connected to the at least one processor.

The memory stores instructions executable by the at least one processor, and the instructions are executed by the at least one processor to cause the at least one processor to perform steps in a 3D target detection module.

The 3D target detection module is configured to input an image into a target detection model and identify a 3D target space and a target category of the 3D target space in the image; where the target detection model is trained and obtained according to the training method for a target detection model according to any embodiment of the present disclosure.

According to another aspect of the present disclosure, a non-transitory computer-readable storage medium is provided, which stores computer instructions for causing a computer to perform the training method for a target detection model according to any embodiment of the present disclosure or the target detection method according to any embodiment of the present disclosure.

In embodiments of the present disclosure, the accuracy of target detection can be improved and the cost of target detection can be reduced.

It is to be understood that the content described in this part is neither intended to identify key or important features of embodiments of the present disclosure nor intended to limit the scope of the present disclosure. Other features of the present disclosure are apparent from the description provided hereinafter.

### BRIEF DESCRIPTION OF DRAWINGS

The drawings are intended to provide a better understanding of the solution and not to limit the present disclosure.

FIG. 1 is a schematic diagram of a training method for a target detection model according to an embodiment of the present disclosure;

FIG. 2 is a schematic diagram of a training method for a target detection model according to an embodiment of the present disclosure;

FIG. 3 is a schematic diagram of an intersection over union according to an embodiment of the present disclosure;

FIG. 4 is a schematic diagram of a training method for a target detection model according to an embodiment of the present disclosure;

FIG. 5 is a training scene diagram of a target detection model according to an embodiment of the present disclosure;

FIG. 6 is a schematic diagram of a target detection method according to an embodiment of the present disclosure;

FIG. 7 is a schematic diagram of a training apparatus for a target detection model according to an embodiment of the present disclosure;

FIG. 8 is a schematic diagram of a target detection apparatus according to an embodiment of the present disclosure; and

FIG. 9 is a schematic diagram of an electronic device for implementing a training method for a target detection model or a target detection method according to an embodiment of the present disclosure.

### DETAILED DESCRIPTION

Example embodiments of the present disclosure, including details of embodiments of the present disclosure, are described hereinafter in conjunction with the drawings to facilitate understanding. The example embodiments are merely illustrative. Therefore, it will be appreciated by those having ordinary skill in the art that various changes and modifications may be made to the embodiments described herein without departing from the scope and spirit of the present disclosure. Similarly, description of well-known functions and constructions is omitted hereinafter for clarity and conciseness.

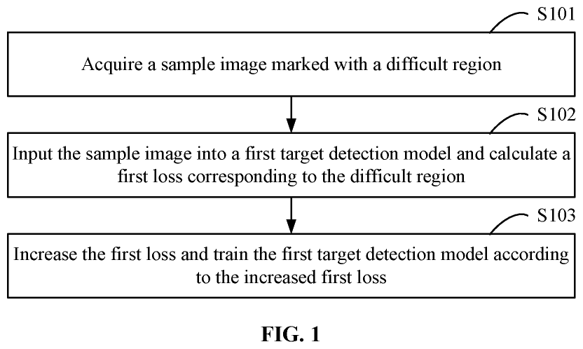

FIG. 1 is a flowchart of a training method for a target detection model according to an embodiment of the present disclosure. This embodiment may be applied to a case of training a target detection model for achieving 3D target detection. The method of this embodiment may be performed by a training apparatus for a target detection model. The apparatus may be implemented by software and/or hardware and is specifically configured in an electronic device having a certain data computing capability. The electronic device may be a client device or a server device. The client device is, for example, a mobile phone, a tablet computer, an in-vehicle terminal, a desktop computer and the like.

In S101, a sample image marked with a difficult region is acquired.

The sample image is used for training a target detection model. The sample image is a monocular 2D image. The monocular image refers to an image taken at one angle, and the sample image does not have depth information. An image collection module performs collection in a set scene environment to obtain the sample image. For example, a camera on a vehicle collects road conditions ahead to obtain the sample image.

The difficult region refers to a region formed by a projection of a difficult 3D object with a poor prediction effect of a first target detection model on a plane. The prediction effect is used for determining whether the first target detection model can accurately predict the 3D object. The 3D object may be represented by attribute information such as space key point coordinates, a space length, a space width, a space height, and a space orientation angle. A first detection result outputted by the first target detection model represents a 3D object, and different first detection results correspond to different 3D objects. Correspondingly, the first detection result of the first target detection model may be defined as N_{A}×D, where D={LWH, XYZ, ry}, which is a 7-dimensional detection result, L denotes a length, W denotes a width, H denotes a height, XYZ denotes (object) center point coordinates, and ry denotes an orientation angle. N denotes a number of detected first detection results, and N_{A} denotes an A-th first detection result. One first detection result is projected onto a 2D image through intrinsic camera parameters so that 8 projection points may be obtained, and a circumscribing region of the 8 projection points is determined to be a first detection region. The circumscribing region may be a circumscribing rectangle.

In a process of training the target detection model, a 3D object as a true value is generally configured and determined to be a standard 3D object, where the standard 3D object is used for verifying whether the first detection result is correct. The standard 3D object is projected onto a 2D image so that 8 projection points are obtained, and a circumscribing region of the 8 projection points is determined to be a standard region of the standard 3D object. The difficult 3D object is a type of 3D object obtained by classifying standard 3D objects. The difficult 3D object is projected onto a 2D image so as to form a difficult region. Moreover, the difficult 3D object is obtained by classifying the standard 3D objects, and correspondingly, the difficult region is a type of region obtained by classifying standard regions marked on the sample image. The classification of standard regions is actually equivalent to the classification of standard 3D objects. In the case where the aforementioned first detection result is accurate, it is determined that the first detection region is the same as or similar to the standard region. The difficult region which is marked in the sample image refers to a circumscribing region of a projection on the sample image of the difficult 3D object which is marked in the sample image.

The step of classifying the standard regions to determine the difficult region may specifically be, for example, comparing the region obtained by projecting a 3D target detection result outputted by the first target detection model with a corresponding standard region and determining a category of the corresponding standard region according to a comparison result. Exemplarily, the comparison result is a region similarity value, and in the case where the similarity value is less than a preset similarity degree, it is determined that the prediction effect is poor and the standard region is determined to be the difficult region. For another example, generally, the standard regions may be classified according to the complexity of a local image corresponding to the standard region, so as to determine the difficult region. The complexity may be determined according to an occlusion degree of the 3D object in the sample image, a perspective of the 3D object, a distance between 3D objects, and image quality (background noise or blur and the like) and the like. Exemplarily, based on a pre-trained complexity detection model, the complexity of the local image corresponding to the standard region may be determined and the standard regions may be classified so as to obtain the difficult region.

In S102, the sample image is inputted into a first target detection model and a first loss corresponding to the difficult region is calculated.

The first target detection model is used for identifying a 3D object according to a monocular image, and specifically identifying space key point coordinates, a space length, a space width, a space height, and a space orientation angle of the 3D object. Exemplarily, the first target detection model may be a neural network model, which may include, for example, an encoding network, a classification network, and the like. The first target detection model is a pre-trained model, that is, a model that has been trained but has not reached a training target. The sample image is inputted into the first target detection model so that at least one first detection result is obtained and projected onto an image so as to obtain the first detection region, and the image where the projection is located may be the sample image. The first detection region is a projection region of a determined 3D object in the image when the first target detection model performs 3D object recognition on the sample image. The first loss corresponding to the difficult region may refer to a difference between the difficult 3D object projected to form the difficult region and the first detection result of the first detection region corresponding to the formed projection.

Exemplarily, a spatial attribute of the 3D object forming the region is determined to be a spatial attribute of the region, and a category of the 3D object forming the region is determined to be a category of the region. The calculation of the first loss may include acquiring the first detection region with the difficult region as a true value according to space key point coordinates in a spatial attribute of each first detection region and space key point coordinates in a spatial attribute of each difficult region and determining that the first detection region corresponds to the difficult region; determining a space loss corresponding to each difficult region according to the spatial attribute of each difficult region and the spatial attribute of the corresponding first detection region, where the spatial attribute includes at least one of the following: a space length, a space width, a space height, or a space orientation angle; determining a category loss according to a first detection category of the first detection region and a target category of the difficult region; and determining the first loss according to the space loss and the category loss corresponding to each difficult region. A correspondence is established between a difficult region formed by difficult 3D objects whose space key point coordinates are close and the first detection region formed by the first detection result, where close space key point coordinates may indicate that a distance between two coordinates may be less than or equal to a set distance threshold. In the case where the difficult region does not have a corresponding first detection region, the first detection region is empty and the first loss is calculated according to the difficult region.

The spatial attribute includes multiple elements and a vector may be generated according to the multiple elements. A spatial attribute of a region are actually a spatial attribute of a 3D object projected to form the region. Exemplarily, the step of calculating a difference between the spatial attribute of the difficult region and the spatial attribute of the corresponding first detection region may include calculating a vector difference between the spatial attribute of the difficult region and the spatial attribute of the corresponding first detection region, that is, calculating a space length difference, a space width difference, a space height difference, and a space orientation angle difference between the difficult region and the corresponding first detection region, and determining the space loss of the first detection region. In the case where the difficult region does not have a corresponding first detection region, the space loss of the difficult region is determined according to a space length difference, a space with difference, a space height difference, and a space orientation angle difference between the difficult region and an empty first detection region (a space length, a space width, a space height, and a space orientation angle may all be 0).

The category is used for representing a category of content in the region, for example, the category includes at least one of the following: vehicles, bicycles, trees, marking lines, pedestrians, or lights. Generally, the category is represented by a specified value. A value difference corresponding to categories of the difficult region and the corresponding first detection region may be calculated and determined to be the category loss of the difficult region. In the case where the difficult region does not have a corresponding first detection region, the category loss of the difficult region is determined according to a value difference corresponding to categories of the difficult region and the empty first detection region (a value corresponding to the category is 0).

The space loss and the category loss of the aforementioned at least one difficult region are accumulated so as to determine the first loss. The space loss of at least one difficult region may be counted so as to obtain a space loss of the first target detection model, the category loss of at least one difficult region may be counted so as to obtain a category loss of the first target detection model, and the space loss of the first target detection model and the category loss of the first target detection model are weighted and accumulated so as to obtain the first loss corresponding to the difficult region. In addition, there are other accumulation methods, which are not specifically limited.

In S103, the first loss is increased and the first target detection model is trained according to the increased first loss.

Increasing the first loss is used for increasing a proportion of the first loss so that the first target detection model pays more attention to the difficult region, thereby improving a capability of learning features in the difficult region. Increasing the first loss may be multiplying the first loss by a proportional coefficient, or accumulating a specified value for the first loss, or the like.

Existing monocular 3D detection detects a space surrounding the 3D object based on the image. However, due to shooting problems of a perspective effect, occlusion, a shadow, and a long distance of a single image, the accuracy of 3D detection based on a monocular image is low.

According to the technical solution of the present disclosure, the difficult region is marked in the sample image, the first loss corresponding to the difficult region is calculated, the first loss is increased, and the proportion of the first loss is increased so that the first target detection model pays more attention to the difficult region, thereby improving the capability of learning features in the difficult region, improving a prediction accuracy of the first target detection model for the difficult region, and improving a target detection accuracy of the 3D object.

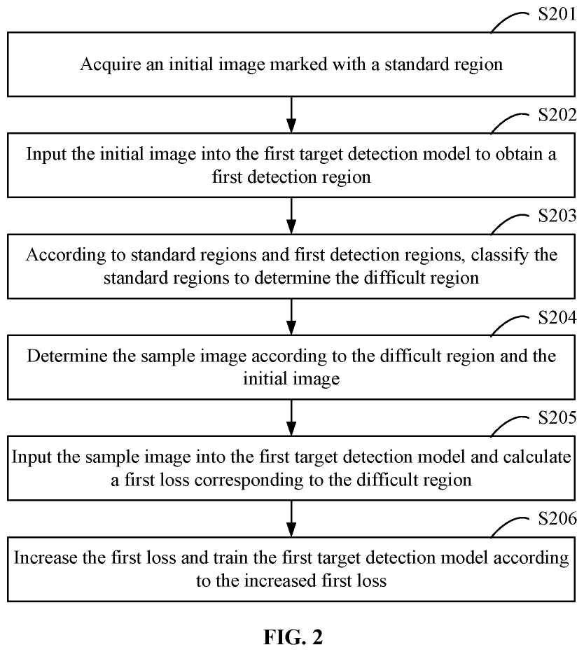

FIG. 2 is a flowchart of another training method for a target detection model according to an embodiment of the present disclosure. The training method for a target detection model is further optimized and extended based on the preceding technical solution and may be combined with the preceding various optional embodiments. The step of acquiring a sample image is embodied as: acquiring an initial image marked with a standard region; inputting the initial image into the first target detection model to obtain a first detection region; and according to standard regions and first detection regions, classifying the standard regions to determine the difficult region.

In S201, an initial image marked with a standard region is acquired.

The initial image is marked with the standard region, and the initial image and the marked standard region may be a sample required for general training of the first target detection model. The initial image is the same as the sample image. The initial image has no depth information. The initial image is marked with the standard region, and the sample image is marked with the difficult region. Standard regions are classified so as to determine the difficult region. The standard regions include difficult regions and simple regions. The difficult regions and the simple regions are different types of standard regions.

The standard regions are classified so as to determine the difficult regions, the simple regions and the like. The difficult region refers to a region where a difficult 3D object with a poor prediction effect of the first target detection model is projected, and the simple region refers to a region where a simple 3D object with a good prediction effect of the first target detection model is projected. As in the preceding example, the first detection result may be projected on an image according to the first detection result of the first target detection model for each 3D object, and the difficult region and the simple region are distinguished in the standard region according to the first detection region. For example, the region where a 3D object outputted by the first target detection model is projected may be compared with each standard region, where a comparison result is a comparison result of region similarity values. In the case where a similarity value is greater than or equal to a preset similarity, it is determined that a corresponding standard region has a good prediction effect and is determined to be the simple region; and in the case where the similarity value is less than the preset similarity, it is determined that the corresponding standard region has a poor prediction effect and is determined to be the difficult region. As in the preceding example, the difficult region and the simple region may be distinguished according to a complexity of a local image corresponding to the standard region. The standard region with a low complexity is determined to be the simple region; and the standard region with a high complexity is determined to be the difficult region.

3D objects are prevented from being directly distinguished, and regions where 2D images are projected are distinguished so that a classification calculation amount of truth value results may be reduced, thereby improving a classification efficiency.

In S202, the initial image is inputted into the first target detection model so as to obtain a first detection region.

The first detection region is the first detection result obtained by inputting the initial image into the first target detection model. The first target detection model is a pre-trained model and can relatively accurately detect 3D objects in the initial image. It is to be noted that the initial image is the same as the sample image, and two detection results outputted correspondingly by the first target detection model are both first detection results.

In S203, according to standard regions and first detection regions, the standard regions are classified so as to determine the difficult region.

In the case where the first detection region where the first detection result outputted by the first target detection model is projected is correct, the first detection region is the same as the corresponding standard region. That is, one first detection region has one corresponding standard region, and the first detection region is the same as the corresponding standard region. The step of classifying the standard regions may be querying a standard region that does not have a corresponding first detection region from the standard regions, and determining the standard region to be the difficult region; and in the case where a similarity value between the standard region and the corresponding first detection region is less than a set similarity threshold, determining the standard region to be the difficult region. In the case where the similarity value between the standard region and the corresponding first detection region is greater than or equal to the set similarity threshold, the standard region is determined to be the simple region. Whether the standard region has a corresponding first detection region may be determined according to whether region space coordinates of the standard region are the same as region space coordinates of each first detection region. For example, the first detection region with the same region space coordinates as the standard region corresponds to the standard region. For another example, if a distance between the region space coordinates of the standard region and the region space coordinates of the first detection region is less than a set distance threshold, the first detection region corresponds to the standard region. For the corresponding standard region and the first detection region, a similarity value between the standard region and the corresponding first detection region may be calculated through an intersection over union (IOU) of the two regions.

Optionally, the training method for a target detection model further includes inputting the initial image into a second target detection model to obtain a second detection region; the step of according to the standard regions and the first detection regions, classifying the standard regions to determine the difficult region includes according to the standard regions, the first detection regions, and second detection regions, classifying the standard regions to determine the difficult region.

The second target detection model is a trained target detection model, which may be a model that has completed training or a model that has not completed the training. The second target detection model is used for identifying a 3D object according to a monocular image, and specifically identifying information such as space key point coordinates, a space length, a space width, a space height, and a space orientation angle of the 3D object. The first target detection model and the second target detection model have different structures, and a prediction accuracy of the second target detection model is higher than the prediction accuracy of the first target detection model. A complexity of the second target detection model is higher than a complexity of the first target detection model. Exemplarily, a number of network layers of the second target detection model is greater than a number of network layers of the first target detection model, for example, the network layers may be convolutional layers. For another example, the second target detection model is a heavyweight model, and the first target detection model is a lightweight model. Generally speaking, a training effect of the second target detection model is better than that of the first target detection model, but a running speed and a training speed of the second target detection model are slower than those of the first target detection model. The second target detection model is a pre-trained model.

The initial image is inputted into the second target detection model so that at least one second detection result is obtained and projected onto a 2D image, and a circumscribing region is determined to be the second detection region. The second detection region is a projection region of a determined 3D object when the second target detection model performs 3D object recognition on the initial image. The first detection result, the second detection result, and the standard 3D object are all projected onto a same image so as to obtain a corresponding projection circumscribing region, for example, in the sample image.

It is to be understood that a prediction effect of the second target detection model is better than a prediction effect of the first target detection model. For example, a number of regions (objects) that are accurately predicted by the second target detection model is higher than a number of regions (objects) that are accurately predicted by the first target detection model. The standard region where the prediction effect of the second target detection model is good and the prediction effect of the first target detection model is not good may be determined to be the difficult region. In this manner, the prediction accuracy of the first target detection model for the difficult region is improved so that the prediction effect of the first target detection model is continuously aligned with the prediction effect of the second target detection model, and the prediction accuracy of the lightweight model can reach the prediction accuracy of the heavyweight model. A prediction accuracy of a region may represent a prediction accuracy of a detection result that is projected to form the region.

According to the standard region and the corresponding first detection region, the prediction effect of the first target detection model for each standard region may be determined, that is, a standard region with a poor prediction effect of the first target detection model and a standard region with a good prediction effect of the first target detection model are screened out. According to the standard regions and the second detection regions, the prediction effect of the second target detection model for each standard region may be determined, that is, a standard region with a poor prediction effect of the second target detection model and a standard region with a good prediction effect of the second target detection model are screened out. According to the prediction effect of the first target detection model for each standard region and the prediction effect of the second target detection model for each standard region, a standard region with a poor prediction effect of the first target detection model and a good prediction effect of the second target detection model is determined to be the difficult region. At this time, the determined difficult region is used for the first target detection model to be aligned with the second target detection model with respect to the capability of learning features in the difficult region so that the prediction effect of the first target detection model is continuously approaching the prediction effect of the second target detection model.

The second target detection model is additionally configured, the second detection region identified by the second target detection model for the initial image is acquired, according to the standard regions, the second detection regions, and the first detection regions, the standard regions are classified so as to determine the difficult region. In this manner, the first target detection model is aligned with the second target detection model with respect to the capability of learning features in the difficult region so that the prediction effect of the first target detection model is continuously approaching the prediction effect of the second target detection model, thereby improving the prediction accuracy of the first target detection model.

Optionally, the step of according to the standard regions, the first detection regions, and the second detection regions, classifying the standard regions to determine the difficult region includes calculating a similarity value between each of the standard regions and each of the first detection regions and performing regional screening to obtain a first screening region set; calculating a similarity value between each of the standard regions and each of the second detection regions and performing the regional screening to obtain a second screening region set;

calculating a similarity value between each of the first detection regions and each of the second detection regions and performing the regional screening to obtain a third screening region set; determining a same region set according to the second screening region set and the third screening region set; and acquiring a standard region that belongs to the same region set and does not belong to the first screening region set and determining the standard region to be the difficult region.

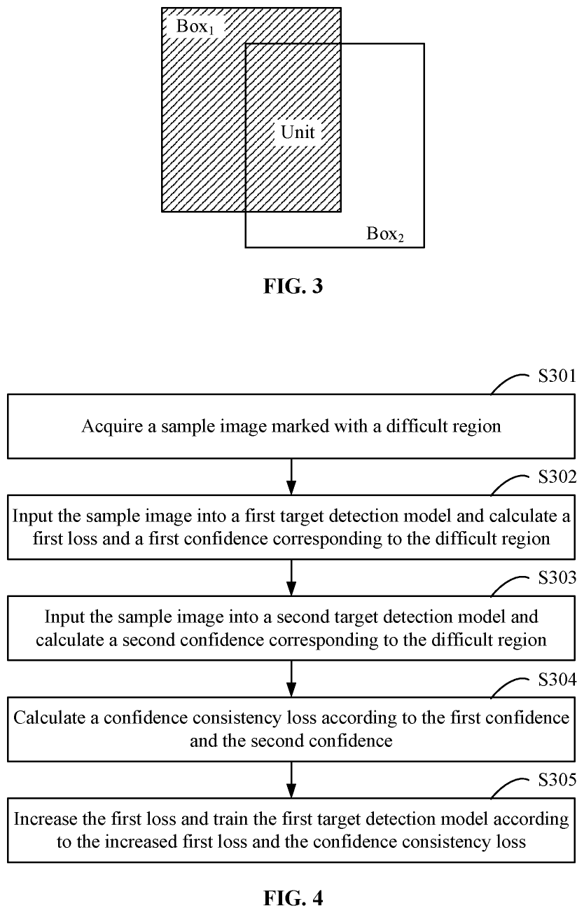

Calculating the similarity value between two regions may be calculating an IOU between the two regions. As shown in FIG. 3, an intersection between a region box₁ and a region box₂ is a region unit, and an IOU between the region box₁ and the region box₂ is calculated based on the formula described below.

$$IOU = \frac{{box}_{1} ⋂ {box}_{2}}{{box}_{1} ⋃ {box}_{2}}$$

A numerator in the above formula is an area of the region unit, and a denominator in the above formula is an area of the intersection between the region box₁ and the region box₂. Based on the above formula, an IOU between the standard region and the first detection region, an IOU between the standard region and the second detection region, and an IOU between the first detection region and the second detection region may be calculated. According to the IOU, two matched regions are formed into a region pair, and a set is generated. The first screening region set is formed by the matched standard region and the first detection region; the second screening region set is formed by the matched standard region and the second detection region; and the third screening region set is formed by the matched first detection region and the second detection region. The regional screening is performed based on a similarity threshold. In the case where the IOU is greater than a set similarity threshold, it is determined that two regions match; and in the case where the IOU is less than or equal to the set similarity threshold, it is determined that the two regions do not match. Exemplarily, the similarity threshold is 0.7. Different similarity thresholds may be configured correspond to different matches. For example, a similarity threshold for a matching calculation between the standard region and the first detection region and a matching calculation between the standard region and the second detection region is a first value; and a similarity threshold for a matching calculation between the first detection region and the second detection region is a second value, where the second value is half of the first value.

In fact, the prediction accuracy of the second target detection model is higher than the prediction accuracy of the first target detection model, and a number of regions included in the second screening region set is greater than a number of regions included in the first screening region set. For example, among matching results between a first detection region A and a standard region GT, there are N_{A1} groups successfully matched; and among matching results between a second detection region B and the standard region GT, there are N_{B1} groups successfully matched, where N_{A1}<N_{B1}.

The same region set is formed by region pairs of same second detection regions existing in the second screening region set and the third screening region set. The difficult region is a standard region that belongs to the same region set and does not belong to the first screening region set, that is, a standard region in region pairs, where these region pairs of the first screening region set are different from regions in region pairs in the same region set. The simple region is a standard region that belongs to the same region set and does not belong to the first screening region set, that is, a standard region in region pairs, where these region pairs of the first screening region set are the same as any region in region pairs in the same region set. A region pair that is the same as a region means that the region exists in the region pair; and a region pair that is different from a region means that the region does not exist in the region pair. The simple region may be understood as a standard region that can be accurately predicted by both the first target detection model and the second target detection model; and the difficult region may be understood as a standard region that cannot be accurately predicted by the first target detection model, but can be accurately predicted by the second target detection model.

For example, among matching results between the first detection region A and the second detection region B, there are N_{AB} groups successfully matched. A region pair where N_{AB}, N_{A1} and N_{B1} all intersect is determined as the simple region, which is denoted as a set {S_{easy}}. A region pair where N_{AB} is not in an N_{A1} set but in an N_{B1} set is determined to be the difficult region, which is denoted as a set {S_{hard}}.

Similarity values between every two of the first detection region the second detection region, and the standard region are calculated, a corresponding screening region set is screened out, a standard region that cannot be accurately predicted by the first target detection model, but can be accurately predicted by the second target detection model is screened out and determined to be the difficult region, and difficult regions may be accurately classified so that the prediction effect of the first target detection model is continuously approaching the prediction effect of the second target detection model, thereby improving the prediction accuracy of the first target detection model.

In S204, the sample image is determined according to the difficult region and the initial image.

The difficult region is marked in the initial image so as to form the sample image.

In S205, the sample image is inputted into the first target detection model and a first loss corresponding to the difficult region is calculated.

In S206, the first loss is increased and the first target detection model is trained according to the increased first loss.

The first target detection model is continuously trained, thereby improving the accuracy of 3D target detection of the first target detection model.

Optionally, the sample image is marked with a simple region. The method includes inputting the sample image into the first target detection model and calculating a second loss of the simple region; the step of training the first target detection model according to the increased first loss includes training the first target detection model according to the increased first loss and the second loss.

The second loss is calculated according to a difference between the simple region and a corresponding first detection region. Exemplarily, an attribute value difference between each corresponding element in a vector formed by a spatial attribute of the simple region and a vector formed by a spatial attribute of the corresponding first detection region and attribute value differences of multiple simple regions may be accumulated so as to determine a space loss of the simple region; a value difference corresponding to categories of the simple region and the corresponding first detection region is calculated, value differences corresponding to categories of multiple simple regions are accumulated, so as to determine a category loss of the simple region. A correspondence between the simple region and the first detection region, the calculation of the space loss, the calculation of the category loss, and the calculation of the second loss may refer to the preceding calculation steps of the first loss.

The sample image is also marked with simple regions so as to distinguish the simple regions from difficult regions. Due to a relatively high prediction accuracy of the first target detection model for the simple region, the calculated second loss of the simple region to which no special attention needs to be paid does not need to be adjusted.

For example, a total loss L of a network is calculated based on the formula described below.

L=Σᵢ₌₀(L_{box3d}+L_{class})|i∈{S_{easy}}+β*Σᵢ₌₀(L_{box3d}+L_{class})|i∈{S_{hard}}

L_{box3d} denotes a space loss, L_{class} denotes a category loss, Σᵢ₌₀(L_{box3d}+L_{class})|i ∈{S_{easy}} denotes a sum of a space loss and a category loss corresponding to at least one simple region, and Σᵢ₌₀(L_{box3d}+L_{class})|i∈{S_{hard}} denotes a sum of a space loss and a category loss corresponding to at least one difficult region. β denotes a weighting coefficient and is greater than 1. The weighted calculation is performed on an obtained loss of the difficult region. A proportion of the loss of the difficult region in the total loss is increased so that the first target detection model network pays more attention to this part of difficult region, thereby achieving a targeted improvement of the capability of learning features in the difficult region.

In conjunction with the increased first loss of the difficult region and the second loss of the simple region that remains unchanged, the first target detection model is trained so that the first target detection model pays more attention to difficult regions and less attention to simple regions, thereby improving the capability of learning features in the difficult region, achieving a targeted improvement of the prediction accuracy of the first target detection model for the difficult region, and improving the target detection accuracy of the 3D object.

According to the technical solution of the present disclosure, the initial image marked with the standard region is acquired, the initial image is inputted into the first target detection model, the first detection region is obtained, according to a difference between the standard region and the first detection region, the standard regions are classified so as to obtain the difficult region, the initial image is marked so as to determine the sample image, and the first target detection model may be used for classifying the standard regions so as to determine the difficult region. In this manner, the acquisition cost of the sample image is reduced, the acquisition efficiency of the sample image is improved, and more samples do not need to be added to train the first target detection model with a higher detection accuracy, thereby improving the accuracy of monocular 3D detection, reducing training costs, and improving a training efficiency without adding additional computation and training data. Moreover, the model for difficult regions is optimized so as to accurately improve the accuracy of 3D target detection.

FIG. 4 is a flowchart of another training method for a target detection model according to an embodiment of the present disclosure. The training method for a target detection model is further optimized and extended based on the preceding technical solution and may be combined with the preceding various optional embodiments. The training method for a target detection model is optimized as follows: inputting the sample image into the first target detection model and calculating a first confidence corresponding to the difficult region; inputting the sample image into a second target detection model and calculating a second confidence corresponding to the difficult region; and calculating a confidence consistency loss according to the first confidence and the second confidence. The step of training the first target detection model according to the increased first loss is embodied as: training the first target detection model according to the increased first loss and the confidence consistency loss.

In S301, a sample image marked with a difficult region is acquired.

In S302, the sample image is inputted into a first target detection model and a first loss and a first confidence corresponding to the difficult region are calculated.

The confidence is used for determining a confidence level of a first detection category of the first detection result. The confidence may refer to a probability that the category of the first detection result is a certain category. Generally, first detection results are classified, and each category corresponds to one confidence, according to each confidence, a category is selected as a first detection category, and a corresponding confidence is determined to be the first confidence. The selected category may be a category with a highest confidence.

In S303, the sample image is inputted into a second target detection model and a second confidence corresponding to the difficult region is calculated.

In S304, a confidence consistency loss is calculated according to the first confidence and the second confidence.

The confidence consistency loss is used for constraining a difference between a confidence obtained by the first target detection model learning in a difficult region and a confidence obtained by the second target detection model learning in the difficult region so that the confidence obtained by the first target detection model in the difficult region is more approaching the confidence obtained by the second target detection model learning in the difficult region. The confidence consistency loss is determined according to a difference between confidences calculated by the first target detection model and the second target detection model respectively for the difficult region.

The confidence consistency loss may be based on a difference between a confidence of the first detection result of the first target detection model for the difficult region and a confidence of the second detection result of the second target detection model for the difficult region. The confidence consistency loss L_{cls_consi} may be calculated based on the formula described below.

L_{cls_consi}=smoothL1(∥cls_{A}ⁱ−cls_{B}ⁱ∥),i∈{S_{hard}}

SmoothL1 denotes an absolute loss function, which means a smooth L1 loss, cls_{A}ⁱ denotes a first confidence of the first target detection model for an i-th difficult region, and cls_{B}ⁱ denotes a second confidence of the second target detection model for the i-th difficult region.

In S305, the first loss is increased and the first target detection model is trained according to the increased first loss and the confidence consistency loss.

Correspondingly, the total loss L is calculated based on the formula described below.

L=Σᵢ₌₀(L_{box3d}+L_{class})|i∈{S_{easy}}+β*Σᵢ₌₀(L_{box3d}+L_{class})|i∈{S_{hard}}+L_{cls_consi}

According to the technical solution of the present disclosure, the second target detection model is additionally configured, the first confidence of the first target detection model and the second confidence of the second target detection model are calculated, and the confidence consistency loss is determined so that the confidence obtained by the first target detection model learning in a difficult region is more approaching the confidence obtained by the second target detection model learning in the difficult region. In this manner, a difference between the capability of the first target detection model learning features in the difficult region and the capability of the second target detection model learning features in the difficult region is reduced, the capability of the first target detection model learning features in the difficult region is improved, and the prediction accuracy of the first target detection model for the difficult region is improved, thereby improving the prediction accuracy of the first target detection model.

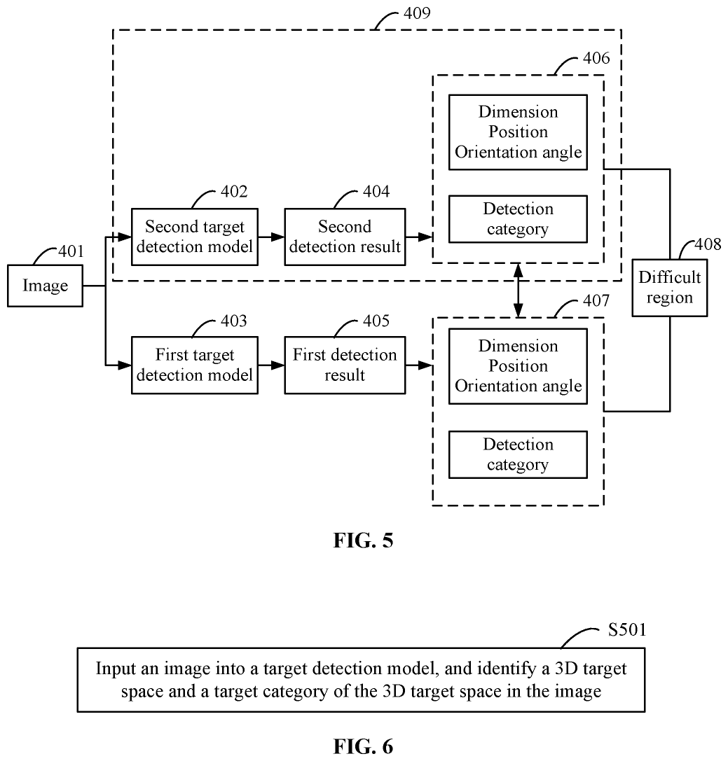

FIG. 5 is a training scene diagram of a target detection model according to an embodiment of the present disclosure.

As shown in FIG. 5, an image 401 is inputted into a first target detection model 403 and a second target detection model 402, respectively, and standard regions marked on the image 401 are classified. A standard 3D object as a true value is projected onto the image 401 so as to form a standard region.

For the first target detection model 403, the image 401 is inputted into the first target detection model 403 so as to obtain a first detection result 405, and the first detection result 405 represents a first spatial attribute such as a dimension, a position, and an orientation angle of one 3D object, a first detection category of the 3D object, and a first confidence corresponding to the first detection category. The first spatial attribute and the first confidence form a unit 407. The position of the 3D object refers to space key point coordinates, and the dimension of the 3D object refers to a space length, a space width, and a space height. The first detection result 405 is projected onto the image 401 through intrinsic camera parameters so that 8 projection points are obtained, and a circumscribing region is determined to be a first detection region of the first detection result 405.

For the second target detection model 402, the image 401 is inputted into the second target detection model 402 so as to obtain a second detection result 404, and the second detection result 404 represents a second spatial attribute such as a dimension, a position, and an orientation angle of one 3D object, a second detection category of the 3D object, a second confidence corresponding to the second detection category. The second spatial attribute and a second confidence form a unit 406. The second detection result 404 is projected onto the image 401 through intrinsic camera parameters so that 8 projection points are obtained, and a circumscribing region is determined to be a second detection region of the second detection result 404.

IOU matching is performed on every two of each first detection region, each second detection region, and the standard region so that a first screening region set formed by region pairs of the matched first detection regions and standard regions, a second screening region set formed by region pairs of the matched second detection regions and standard regions, a third screening region set formed by region pairs of the matched first detection regions and second detection regions. Same region pairs in the second screening region set and the third screening region set are acquired, region pairs the same as region pairs of the first screening region set are eliminated, and standard regions are acquired in the remaining region pairs and determined to be difficult regions 408. Same region pairs in the first screening region set, the second screening region set, and the third screening region set are acquired, and standard regions are acquired in the same region pairs and determined to be simple regions.

The simple regions and the difficult regions are marked in the image 401. The image 401 is respectively inputted into the first target detection model 403 and the second target detection model 402 again, and the first target detection model 403 and the second target detection model 402 are trained respectively.

The first target detection module 403 calculates and accumulates a space loss and a category loss with the first detection result for at least one difficult 3D object forming the difficult region, so as to determine the first loss corresponding to the difficult region. A space loss and a category loss with the first detection result for at least one simple 3D object forming the simple region are calculated and accumulated, so as to determine the second loss corresponding to the simple region. A difference between the first confidence of the first target detection module 403 and the second confidence of the second target detection model 402 for at least one difficult 3D object forming the difficult region is calculated, so as to determine the confidence consistency loss. The first loss is increased, a total loss of the first target detection module 403 is determined according to the increased first loss, the second loss and the confidence consistency loss, the first target detection module 403 is trained, and parameters of the first target detection module 403 are adjusted.

Whether the training of the first target detection module 403 is completed may be determined based on whether parameters of a gradient descent method converge. In the case where the training of the first target detection module 403 is completed, the first target detection module 403 may be deployed in a device to identify 3D objects and corresponding categories for monocular 2D images. The second target detection model is only used in a training stage, and in an application stage of the first target detection module 403, training content 409 of the second target detection model is eliminated.

The second target detection model guides the training of the first target detection model. In a testing stage, only the same data set needs to be provided to train the first target detection model and the second target detection model at the same time. Alternatively, only the first target detection model is trained, the second target detection model has completed training, and during application, only the first target detection model is retained, a branch of the second target detection model is eliminated, a running speed and detection accuracy of the first target detection model are ensured at the same time, and more samples do not need to be added to train the first target detection model with a higher detection accuracy, thereby improving the accuracy of monocular 3D detection and reducing training costs without adding additional computation and training data.

FIG. 6 is a flowchart of a target detection method according to an embodiment of the present disclosure. This embodiment may be applied to a case of identifying a region of a 3D object according to a trained target detection model and a monocular image. The method of this embodiment may be performed by a target detection apparatus. The apparatus may be implemented by software and/or hardware and is specifically configured in an electronic device having a certain data computing capability. The electronic device may be a client device or a server device. The client device is, for example, a mobile phone, a tablet computer, an in-vehicle terminal, a desktop computer and the like.

In S501, an image is inputted into a target detection model, and a 3D target space and a target category of the 3D target space are identified in the image; where the target detection model is trained and obtained according to the training method for a target detection model according to any embodiment of the present disclosure.

The image is a 2D monocular image for a 3D object that needs to be identified. The 3D target space surrounds the 3D object. The target category of the 3D target space refers to a category of an object surrounded by the 3D target space.

For example, in a field of traffic, a camera on a vehicle collects an image of a road scene ahead and inputs the image into the target detection model so as to obtain a target space in the road scene ahead where the target category is a vehicle, a target space where the target category is a pedestrian, a target space where the target category is an indicator light and the like.

For another example, in a cell monitoring scene, a camera configured in the cell collects an image of the cell scene. The image is inputted into the target detection model so as to obtain a target space in the cell scene where the target category is the elderly, a target space where the target category is children, a target space where the target category is the vehicle and the like.

According to the technical solution of the present disclosure, the target detection model is obtained through the training method for a target detection model according to any embodiment of the present disclosure, and target detection is performed on the image based on the target detection model so as to obtain the 3D target space and the corresponding target category, thereby improving the accuracy of 3D target detection, speeding up a detection efficiency of target detection, and reducing the computational cost and deployment cost of target detection.

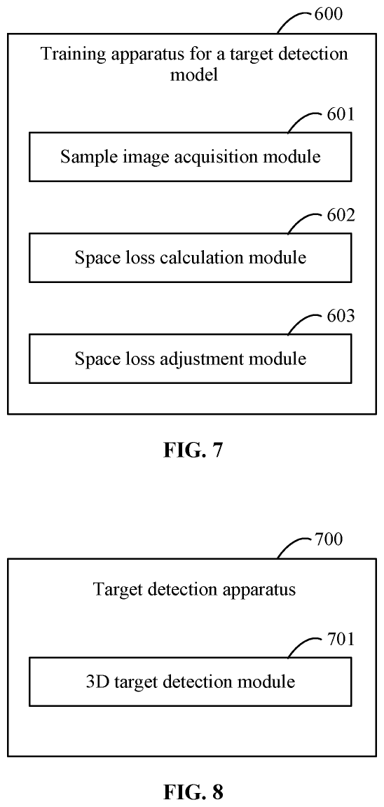

According to an embodiment of the present disclosure, FIG. 7 is a structural diagram of a training apparatus for a target detection model according to an embodiment of the present disclosure, and the embodiment of the present disclosure is applicable to a case of training a target detection model for achieving 3D target detection. The apparatus is implemented by software and/or hardware and is specifically configured in an electronic device having a certain data computing capability.

As shown in FIG. 7, a training apparatus 600 for a target detection model includes a sample image acquisition module 601, a space loss calculation module 602, and a space loss adjustment module 603.

The sample image acquisition module 601 is configured to acquire a sample image marked with a difficult region.

The space loss calculation module 602 is configured to input the sample image into a first target detection model and calculate a first loss corresponding to the difficult region.

The space loss adjustment module 603 is configured to increase the first loss and train the first target detection model according to the increased first loss.

According to the technical solution of the present disclosure, the difficult region is marked in the sample image, the first loss corresponding to the difficult region is calculated, the first loss is increased, and the proportion of the first loss is increased so that the first target detection model pays more attention to the difficult region, thereby improving the capability of learning features in the difficult region, improving a prediction accuracy of the first target detection model for the difficult region, and improving a target detection accuracy of the 3D object.

Further, the sample image acquisition module 601 includes an initial image acquisition unit, a first detection region acquisition unit, a standard region classification unit, and a sample image generation unit. The initial image acquisition unit is configured to acquire an initial image marked with a standard region. The first detection region acquisition unit is configured to input the initial image into the first target detection model to obtain a first detection region. The standard region classification unit is configured to, according to standard regions and first detection regions, classify the standard regions to determine the difficult region. The sample image generation unit is configured to determine the sample image according to the difficult region and the initial image.

Further, the training apparatus for a target detection model further includes a second detection region acquisition unit configured to input the initial image into a second target detection model to obtain a second detection region. The standard region classification unit includes a region matching subunit configured to, according to the standard regions, the first detection regions, and second detection regions, classify the standard regions to determine the difficult region.

Further, the region matching subunit unit includes a first region matching subunit, a second region matching subunit, a third region matching subunit, a same region screening subunit, and a difficult region determination subunit. The first region matching subunit is configured to calculate a similarity value between each of the standard regions and each of the first detection regions and perform regional screening to obtain a first screening region set. The second region matching subunit is configured to calculate a similarity value between each of the standard regions and each of the second detection regions and perform the regional screening to obtain a second screening region set. The third region matching subunit is configured to calculate a similarity value between each of the first detection regions and each of the second detection regions and perform the regional screening to obtain a third screening region set. The same region screening subunit is configured to determine a same region set according to the second screening region set and the third screening region set. The difficult region determination subunit is configured to acquire a standard region that belongs to the same region set and does not belong to the first screening region set and determine the standard region to be the difficult region.

Further, the training apparatus for a target detection model further includes a first confidence calculation module, a second confidence calculation module, and a confidence loss calculation module. The first confidence calculation module is configured to input the sample image into the first target detection model and calculate a first confidence corresponding to the difficult region. The second confidence calculation module is configured to input the sample image into a second target detection model and calculate a second confidence corresponding to the difficult region. The confidence loss calculation module is configured to calculate a confidence consistency loss according to the first confidence and the second confidence. The space loss adjustment module 603 includes a confidence loss adjustment unit configured to train the first target detection model according to the increased first loss and the confidence consistency loss.

Further, the sample image is marked with a simple region; the training apparatus for a target detection model further includes a second loss calculation module configured to input the sample image into the first target detection model and calculate a second loss of the simple region; the space loss adjustment module 603 includes a loss weighted calculation unit configured to train the first target detection model according to the increased first loss and the second loss.

The training apparatus for a target detection model may perform the training method for a target detection model provided by any embodiment of the present disclosure and has function modules and beneficial effects corresponding to the performed training method for a target detection model.

According to an embodiment of the present disclosure, FIG. 8 is a structural diagram of a target detection apparatus according to an embodiment of the present disclosure. The embodiment of the present disclosure is applicable to a case of identifying a region of a 3D object according to a trained target detection model and a monocular image. The apparatus is implemented by software and/or hardware and is specifically configured in an electronic device having a certain data computing capability.

As shown in FIG. 8, a target detection apparatus 700 includes a 3D target detection module 701.

The 3D target detection module 701 is configured to input an image into a target detection model and identify a 3D target space and a target category of the 3D target space in the image; where the target detection model is trained and obtained according to the training method for a target detection model according to any embodiment of the present disclosure.

According to the technical solution of the present disclosure, the target detection model is obtained through the training method for a target detection model according to any embodiment of the present disclosure, and target detection is performed on the image based on the target detection model so as to obtain the 3D target space and the corresponding target category, thereby improving the accuracy of 3D target detection, speeding up a detection efficiency of target detection, and reducing the computational cost and deployment cost of target detection.

The preceding target detection apparatus may perform the target detection method provided by any embodiment of the present disclosure and has function modules and beneficial effects corresponding to the performed target detection method.

In the technical solutions of the present disclosure, the collection, storage, use, processing, transmission, provision, and disclosure of user personal information involved are in compliance with provisions of relevant laws and regulations and do not violate public order and good customs.

According to the embodiments of the present disclosure, the present disclosure further provides an electronic device, a readable storage medium and a computer program product.

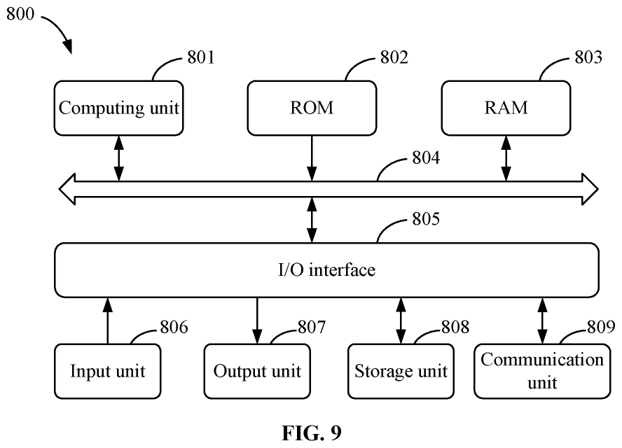

FIG. 9 is a schematic diagram of an exemplary electronic device 800 that may be used for implementing the embodiments of the present disclosure. The electronic device is intended to represent various forms of digital computers, for example, a laptop computer, a desktop computer, a worktable, a personal digital assistant, a server, a blade server, a mainframe computer or another applicable computer. The electronic device may also represent various forms of mobile devices, for example, a personal digital assistant, a cellphone, a smartphone, a wearable device or another similar computing device. Herein the shown components, the connections and relationships between these components, and the functions of these components are illustrative only and are not intended to limit the implementation of the present disclosure as described and/or claimed herein.

As shown in FIG. 9, the device 800 includes a computing unit 801. The computing unit 801 may perform various types of appropriate operations and processing based on a computer program stored in a read-only memory (ROM) 802 or a computer program loaded from a storage unit 808 to a random-access memory (RAM) 803. Various programs and data required for operations of the device 800 may also be stored in the RAM 803. The computing unit 801, the ROM 802 and the RAM 803 are connected to each other through a bus 804. An input/output (I/O) interface 805 is also connected to the bus 804.

Multiple components in the device 800 are connected to the I/O interface 805. The components include an input unit 806 such as a keyboard and a mouse, an output unit 807 such as various types of displays and speakers, the storage unit 808 such as a magnetic disk and an optical disc, and a communication unit 809 such as a network card, a modem and a wireless communication transceiver. The communication unit 809 allows the device 800 to exchange information/data with other devices over a computer network such as the Internet and/or various telecommunications networks.

The computing unit 801 may be various general-purpose and/or special-purpose processing components having processing and computing capabilities. Examples of the computing unit 801 include, but are not limited to, a central processing unit (CPU), a graphics processing unit (GPU), a special-purpose artificial intelligence (AI) computing chip, a computing unit executing machine learning models and algorithms, a digital signal processor (DSP) and any appropriate processor, controller and microcontroller. The computing unit 801 executes various methods and processing described above, such as the training method for a target detection model or the target detection method. For example, in some embodiments, the training method for a target detection model or the target detection method may be implemented as a computer software program tangibly contained in a machine-readable medium such as the storage unit 808. In some embodiments, part or all of computer programs may be loaded and/or installed on the device 800 via the ROM 802 and/or the communication unit 809. When the computer programs are loaded into the RAM 803 and executed by the computing unit 801, one or more steps of the preceding training method for a target detection model or the preceding target detection method may be performed. Alternatively, in other embodiments, the computing unit 801 may be configured, in any other suitable manner (for example, by means of firmware), to execute the training method for a target detection model or the target detection method.

Herein various embodiments of the systems and techniques described above may be implemented in digital electronic circuitry, integrated circuitry, field-programmable gate arrays (FPGAs), application-specific integrated circuits (ASICs), application-specific standard products (ASSPs), systems on chips (SOCs), complex programmable logic devices (CPLDs), computer hardware, firmware, software, and/or combinations thereof. The various embodiments may include implementations in one or more computer programs. The one or more computer programs are executable and/or interpretable on a programmable system including at least one programmable processor. The programmable processor may be a special-purpose or general-purpose programmable processor for receiving data and instructions from a memory system, at least one input apparatus, and at least one output apparatus and transmitting the data and instructions to the memory system, the at least one input apparatus, and the at least one output apparatus.

Program codes for implementing the methods of the present disclosure may be compiled in any combination of one or more programming languages. The program codes may be provided for the processor or controller of a general-purpose computer, a special-purpose computer, or another programmable data processing apparatus to enable functions/operations specified in flowcharts and/or schematic diagrams to be implemented when the program codes are executed by the processor or controller. The program codes may be executed in whole on a machine, executed in part on a machine, executed, as a stand-alone software package, in part on a machine and in part on a remote machine, or executed in whole on a remote machine or a server.

In the context of the present disclosure, a machine-readable medium may be a tangible medium that may include or store a program that is used by or in conjunction with an instruction execution system, apparatus or device. The machine-readable medium may be a machine-readable signal medium or a machine-readable storage medium. The machine-readable medium may include, but is not limited to, an electronic, magnetic, optical, electromagnetic, infrared or semiconductor system, apparatus or device, or any suitable combination thereof.

More specific examples of the machine-readable storage medium may include an electrical connection based on one or more wires, a portable computer disk, a hard disk, a random-access memory (RAM), a read-only memory (ROM), an erasable programmable read-only memory (EPROM) or a flash memory, an optical fiber, a portable compact disk read-only memory (CD-ROM), an optical memory device, a magnetic memory device, or any suitable combination thereof

In order that interaction with a user is provided, the systems and techniques described herein may be implemented on a computer. The computer has a display apparatus (for example, a cathode-ray tube (CRT) or a liquid-crystal display (LCD) monitor) for displaying information to the user and a keyboard and a pointing apparatus (for example, a mouse or a trackball) through which the user can provide input to the computer. Other types of apparatuses may also be used for providing interaction with a user. For example, feedback provided for the user may be sensory feedback in any form (for example, visual feedback, auditory feedback, or haptic feedback). Moreover, input from the user may be received in any form (including acoustic input, voice input, or haptic input).

The systems and techniques described herein may be implemented in a computing system including a back-end component (for example, a data server), a computing system including a middleware component (for example, an application server), a computing system including a front-end component (for example, a client computer having a graphical user interface or a web browser through which a user can interact with implementations of the systems and techniques described herein), or a computing system including any combination of such back-end, middleware or front-end components. Components of a system may be interconnected by any form or medium of digital data communication (for example, a communication network). Examples of the communication network include a local area network (LAN), a wide area network (WAN) and the Internet.

The computing system may include clients and servers. The clients and servers are usually far away from each other and generally interact through the communication network. The relationship between the clients and the servers arises by virtue of computer programs running on respective computers and having a client-server relationship to each other. The server may be a cloud server, a server of a distributed system or a server combined with a blockchain.

It is to be understood that various forms of the preceding flows may be used with steps reordered, added, or removed. For example, the steps described in the present disclosure may be executed in parallel, in sequence or in a different order as long as the desired result of the technical solutions disclosed in the present disclosure is achieved. The execution sequence of these steps is not limited herein.

The scope of the present disclosure is not limited to the preceding embodiments. It is to be understood by those skilled in the art that various modifications, combinations, subcombinations and substitutions may be made according to design requirements and other factors. Any modification, equivalent substitution, improvement and the like made within the spirit and principle of the present disclosure falls within the scope of the present disclosure.

What is claimed is:

1. A training method for a target detection model, comprising:
acquiring a sample image marked with a difficult region;
inputting the sample image into a first target detection model and calculating a first loss corresponding to the difficult region; and
increasing the first loss and training the first target detection model according to the increased first loss.

2. The method of claim 1, wherein acquiring the sample image comprises:
acquiring an initial image marked with at least one standard region;
inputting the initial image into the first target detection model to obtain at least one first detection region;
according to the at least one standard region and the at least one first detection region, classifying the at least one standard region to determine the difficult region; and
determining the sample image according to the difficult region and the initial image.

3. The method of claim 2, further comprising:
inputting the initial image into a second target detection model to obtain at least one second detection region;
wherein according to the at least one standard region and the at least one first detection region, classifying the at least one standard region to determine the difficult region comprises:
according to the at least one standard region, the at least one first detection region, and the at least one second detection region, classifying the at least one standard region to determine the difficult region.

4. The method of claim 3, wherein according to the at least one standard region, the at least one first detection region, and the at least one second detection region, classifying the at least one standard region to determine the difficult region comprises:
calculating a similarity value between each of the at least one standard region and each of the at least one first detection region and performing regional screening to obtain a first screening region set;
calculating a similarity value between each of the at least one standard region and each of the at least one second detection region and performing regional screening to obtain a second screening region set;
calculating a similarity value between each of the at least one first detection region and each of the at least one second detection region and performing regional screening to obtain a third screening region set;
determining a same region set according to the second screening region set and the third screening region set; and
acquiring a standard region that belongs to the same region set and does not belong to the first screening region set from the at least one standard region and determining the standard region to be the difficult region.

5. The method of claim 1, further comprising:
inputting the sample image into the first target detection model and calculating a first confidence corresponding to the difficult region;
inputting the sample image into a second target detection model and calculating a second confidence corresponding to the difficult region; and
calculating a confidence consistency loss according to the first confidence and the second confidence;
wherein training the first target detection model according to the increased first loss comprises: training the first target detection model according to the increased first loss and the confidence consistency loss.

6. The method of claim 1, wherein
the sample image is marked with a simple region; and the method comprises: inputting the sample image into the first target detection model and calculating a second loss of the simple region; and
training the first target detection model according to the increased first loss comprises: training the first target detection model according to the increased first loss and the second loss.

7. A target detection method, comprising:
inputting an image into a target detection model and identifying a 3D target space and a target category of the 3D target space in the image;
wherein the target detection model is trained and obtained according to the training method for a target detection model of claim 1.

8. A training apparatus for a target detection model, comprising:
at least one processor; and
a memory communicatively connected to the at least one processor, wherein
the memory stores instructions executable by the at least one processor, and the instructions are executed by the at least one processor to cause the at least one processor to:
acquire a sample image marked with a difficult region;
input the sample image into a first target detection model and calculate a first loss corresponding to the difficult region; and
increase the first loss and train the first target detection model according to the increased first loss.

9. The apparatus of claim 8, wherein the processor acquires the sample image marked with the difficult region by:
acquiring an initial image marked with at least one standard region;
inputting the initial image into the first target detection model to obtain at least one first detection region;
according to the at least one standard region and the at least one first detection region, classifying the at least one standard region to determine the difficult region; and
determining the sample image according to the difficult region and the initial image.

10. The apparatus of claim 9, wherein the processor is further configured to:
input the initial image into a second target detection model to obtain at least one second detection region;
wherein the processor classifies the at least one standard region to determine the difficult region by:
according to the at least one standard region, the at least one first detection region, and the at least one second detection region, classifying the at least one standard region to determine the difficult region.

11. The apparatus of claim 10, wherein the processor classifies the at least one standard region to determine the difficult region by:
calculating a similarity value between each of the at least one standard region and each of the at least one first detection region and performing regional screening to obtain a first screening region set;
calculating a similarity value between each of the at least one standard region and each of the at least one second detection region and performing regional screening to obtain a second screening region set;
calculating a similarity value between each of the at least one first detection region and each of the at least one second detection region and performing regional screening to obtain a third screening region set;
determining a same region set according to the second screening region set and the third screening region set; and
acquiring a standard region that belongs to the same region set and does not belong to the first screening region set from the at least one standard region and determining the standard region to be the difficult region.

12. The apparatus of claim 8, wherein the processor is further configured to:
input the sample image into the first target detection model and calculate a first confidence corresponding to the difficult region;
input the sample image into a second target detection model and calculate a second confidence corresponding to the difficult region; and
calculate a confidence consistency loss according to the first confidence and the second confidence;
wherein the processor trains the first target detection model according to the increased first loss by training the first target detection model according to the increased first loss and the confidence consistency loss.

13. The apparatus of claim 8, wherein
the sample image is marked with a simple region; and the processor is further configured to input the sample image into the first target detection model and calculate a second loss of the simple region; and
the processor trains the first target detection model according to the increased first loss by training the first target detection model according to the increased first loss and the second loss.

14. A target detection apparatus, comprising:
at least one processor; and
a memory communicatively connected to the at least one processor, wherein
the memory stores instructions executable by the at least one processor, and the instructions are executed by the at least one processor to cause the at least one processor to:
input an image into a target detection model and identify a 3D target space and a target category of the 3D target space in the image; wherein the target detection model is trained and obtained according to the training apparatus for a target detection model of claim 8.

15. A non-transitory computer-readable storage medium storing computer instructions for causing a computer to:
acquire a sample image marked with a difficult region;
input the sample image into a first target detection model and calculate a first loss corresponding to the difficult region; and
increase the first loss and training the first target detection model according to the increased first loss.
